(19) United States
(12) Patent Application Publication
(10) Pub. No.: US 2023/0067101 A1
(43) Pub. Date: Mar. 2, 2023

(54) HYDRAULIC DAMPER

(71) Applicant: HONDA MOTOR CO., LTD., Tokyo (JP)

(72) Inventors: Yuichi OKADA, Wako-shi (JP); Nobuhiro YAMADA, Wako-shi (JP)

(21) Appl. No.: 17/890,566

(22) Filed: Aug. 18, 2022

(30) Foreign Application Priority Data
Aug. 31, 2021 (JP) 2021-140816

(51) Int. Cl. F16F 9/516; F16F 9/344; F16F 9/348; F16F 9/19

(52) U.S. Cl. CPC F16F 9/516; F16F 9/344; F16F 9/348; F16F 9/19; F16F 2222/12; B60G 13/08

(57) ABSTRACT

A hydraulic damper includes: a cylinder having a cylinder tube; a piston slidingly movable within the cylinder tube; a piston rod integrally movable with the piston; a first chamber and a second chamber into or from which fluid flows by sliding movement of the piston relative to the cylinder tube; a piston port portion connecting the first chamber and the second chamber; a damping force generating device disposed downstream of the piston port portion through which the fluid flows; and a sub-valve disposed upstream and/or downstream of the damping force generating device. The sub-valve is provided with a sub-valve port portion that is connected to a flow path of the piston port portion. A total cross-sectional area of a flow path of the sub-valve port portion is smaller than a total cross-sectional area of the flow path of the piston port portion.

### CROSS-REFERENCE TO RELATED APPLICATION

This application claims the benefit of foreign priority to Japanese Patent Application No. 2021-140816, filed on Aug. 31, 2021, which is incorporated by reference in its entirety.

### TECHNICAL FIELD

The present invention relates, for example, to a hydraulic damper applied to a vehicle suspension system.

### BACKGROUND

For example, JP 2010-151301 A discloses a variable damping force damper with a leaf valve located downstream of a port in a piston.

In this variable damping force damper, the leaf valve is bent by pressure oil flowing through the port to change the damping force.

In general, in a damper structure using leaf valves, the damping force is set by changing the thickness dimension, number of sheets, shape, etc. of a leaf valve when setting damping force relative to piston displacement speed.

However, because damping force setting values differ depending on types and specifications of vehicles, it is necessary to combine many shapes and a large number of leaf valves. This increases man-hour requirements for development. Even if a damping force generating device is composed, for example, of disc valves, rod valves, spool valves, etc. instead of leaf valves, a large amount of man-hour requirements is required for development.

Further, the conventional technology lacks the degree of freedom of setting (i.e., adjustment to increase or decrease damping force) and the magnitude of absolute value (increasing the damping force cannot be expected in the first place) in a high speed range of piston speed and in an extremely low speed range of piston speed.

In view of the above, an object of the present invention is to provide a hydraulic damper that can reduce the man-hour requirements for development when setting damping force.

Further, an object of the present invention is to provide a hydraulic damper that can increase the degree of freedom of setting and the magnitude of absolute value in a high speed range of piston speed and in an extremely low speed range of piston speed.

### SUMMARY

According to one aspect of the present invention, a hydraulic damper includes: a cylinder having a cylinder tube; a piston slidingly movable within the cylinder tube; a piston rod connected to the piston at one end portion along an axial direction thereof and integrally movable with the piston; a first chamber and a second chamber into or from which fluid flows by sliding movement of the piston relative to the cylinder tube; a piston port portion connecting the first chamber and the second chamber; and a damping force generating device disposed downstream of the piston port portion through which the fluid flows. The hydraulic damper further includes a sub-valve disposed upstream and/or downstream of the damping force generating device. The sub-valve is provided with a sub-valve port portion that is connected to a flow path of the piston port portion, and a total cross-sectional area (S2) of a flow path of the sub-valve port portion is smaller than a total cross-sectional area (S1) of the flow path of the piston port portion (S1>S2).

### BRIEF DESCRIPTION OF THE DRAWINGS

The drawings described herein are for illustration purposes only and are not intended to limit the scope of the present invention in any way.

FIG. 1 is a cross-sectional view of a hydraulic damper according to one embodiment of the present invention, taken along an axial direction of the hydraulic damper.

FIG. 2 is a partially enlarged cross-sectional view of FIG. 1 including a piston.

FIG. 3 is a perspective cross-sectional view showing flow paths of pressure oil at piston port portions and sub-valve port portions.

FIG. 4A is a plan view of a sub-valve.

FIG. 4B is a perspective view of the sub-valve.

FIG. 5 is a partially broken perspective view showing a flowing state of the pressure oil at detention portions provided in the sub-valve.

FIG. 6A is a partially enlarged cross-sectional view showing a sealing state of an O-ring fitted in an annular groove.

FIG. 6B is a schematic diagram showing a modified embodiment of the sub-valve port portion.

FIG. 7A is a cross-sectional view of an amplitude-selective damper to which the sub-valve is applied, taken along an axial direction of the damper.

FIG. 7B is a partially broken perspective view of the sub-valve shown in FIG. 7A.

### DETAILED DESCRIPTION

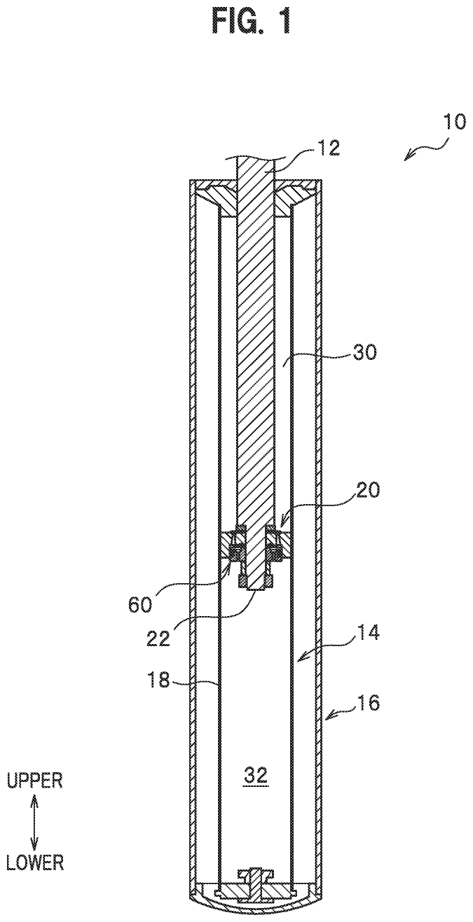

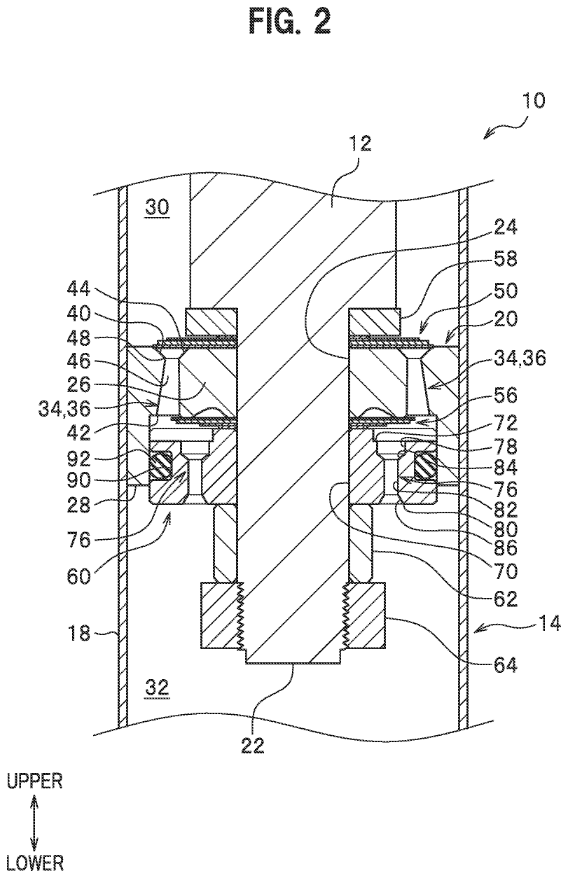

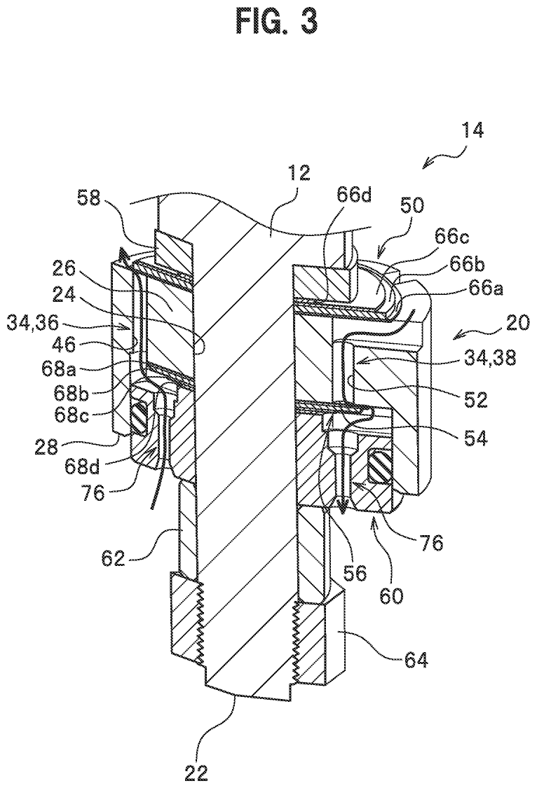

One embodiment of the present invention is described below with reference to the drawings as appropriate. FIG. 1 is a cross-sectional view of a hydraulic damper according to one embodiment of the present invention, taken along an axial direction of the hydraulic damper, FIG. 2 is a partially enlarged cross-sectional view of FIG. 1 including a piston, and FIG. 3 is a perspective cross-sectional view showing flow paths of pressure oil at piston port portions and sub-valve port portions. In each drawing, upper and lower directions indicate upper and lower directions of a vehicle (vertically upper and lower directions).

Because the orientation, such as vertical direction, etc., of a hydraulic damper 10 according to this embodiment changes depending on the installation state thereof, as seen in FIG. 1, the following explanation will be made as an example of the case where a piston rod 12 is located on the upper side and a cylinder 14 is located on the lower side.

The hydraulic damper 10 shown in FIG. 1 is a shock absorbing device that is applied to a suspension system of a vehicle, such as a two-wheeled vehicle and a four-wheeled vehicle, to quickly damp vertical shock and vertical vibration imparted to the vehicle due to unevenness of a road surface during the travel of the vehicle. The hydraulic damper 10 is configured as a variable damping force damper whose damping force can be varied.

As seen in FIG. 1, the hydraulic damper 10 according to this embodiment includes a casing 16, and a cylinder 14 accommodated within the casing 16.

The cylinder 14 includes a piston 20 slidably movable along the vertical direction (upper and lower directions) in the cylinder tube 18, and a piston rod 12 having a lower end portion (one end portion) along an axial direction thereof and an upper end portion (the other end portion) opposite to the lower end portion. The lower end portion of the piston rod 12 is connected to the piston 20, and the upper end portion of the piston rod 12 pierces the cylinder 14 and is exposed to the outside. The piston 20 and piston rod 12 slidably move together. As seen in FIGS. 2 and 3, the piston 20 has a bore 24 at its center portion, and a reduced-diameter rod portion 22 of the piston rod 12 is attached to the bore 24. The piston 20 includes a piston body 26 in the shape of a generally thick disk, and an annular protrusion 28 protruding downward from a lower circumferential edge portion of the piston body 26. The outer circumferential surface of the piston body 26 and the outer circumferential surface of the annular protrusion 28 are continuous and substantially flush with each other. It should be noted that although the piston body 26 and the annular protrusion 28 are integrally formed in this embodiment, the present invention is not limited to this specific configuration. The piston body 26 and the annular protrusion 28 may be formed as separate members and then joined together as an integral unit.

The piston body 26 has piston port portions 34 each consisting of a connecting path for connecting a first chamber 30 and a second chamber 32 in the cylinder tube 18. The piston port portions 34 include a plurality of first connecting paths 36 and a plurality of second connecting paths 38. The first connecting paths 36 and the second connecting paths 38 serve as “flow paths of piston port portions”.

As seen in FIG. 2, each of the first connecting paths 36 includes a first opening 40 formed in an upper surface of the piston body 26, a second opening 42 formed in a lower surface of the piston body 26, a first tapered portion 44 whose diameter decreases from the first opening 40 toward the second opening 42, a second tapered portion 46 whose diameter decreases from the second opening 42 toward the first opening 40, a connecting hole 48 connecting the lower end of the first tapered portion 44 and the upper end of the second tapered portion 46. The first connecting path 36 is held closed when a first leaf valve 50 to be described later is seated on a seating surface.

As seen in FIG. 3, each of the second connecting paths 38 is composed of a path 52 extending vertically through the piston body 26 from a recess formed in the upper surface of the piston body 26 to the lower surface of the piston body 26. An opening 54 is formed at the lower end of the path 52. The opening 54 of the second connecting path 38 is held closed when a second leaf valve 56 to be described later is seated on a seating surface.

The cylinder tube 18 is made of a cylindrical body having openings at both ends along an axial direction thereof. Each of the openings is closed by an end block. The reduced-diameter rod portion 22 is provided at the lower end portion of the piston rod 12. The reduced-diameter rod portion 22 extends downward through an annular stepped portion.

As seen in FIG. 2, the reduced-diameter rod portion 22 is provided, from its top to bottom, with a stopper seat 58, a first leaf valve 50, a piston 20, a second leaf valve 56, a sub-valve 60, and an axial adjustment collar 62, respectively, in this order. The stopper seat 58, the first leaf valve 50, the piston 20, the second leaf valve 56, the sub-valve 60, and the axial adjustment collar 62 are integrally held between the annular stepped portion of the piston rod 12 and a fastening nut 64 fastened to a threaded portion formed on the lower end of the reduced-diameter rod portion 22.

Pressure oil such as oil is filled in the cylinder tube 18. The cylinder 14 is divided by the piston 20 and includes the first chamber 30 (one chamber) and the second chamber 32 (another chamber) into or from which pressure oil (fluid) flows by sliding movement of the piston 20 relative to the cylinder tube 18, piston port portions 34 each connecting the upper first chamber 30 and the lower second chamber 32 that are divided by the piston 20, and the first leaf valve 56 (damping force generating device) and the second leaf valve 56 (damping force generating device) that are disposed downstream of the piston port portions 34 through which the pressure oil flows.

The first leaf valve 50 is located on the upper side of the piston 20 (piston body 26) and downstream of the piston port portions 34, through which the pressure oil flows in a pressing direction (i.e., in a direction from lower to upper). The second leaf valve 56 is located on the lower side of the piston 20 (piston body 26), closer to the bore of the annular protrusion 28, and downstream of the piston port portions 34, through which the pressure oil flows in an extending direction (i.e., in a direction from upper to lower).

The first leaf valve 50 is bent upward to open the valve by means of the pressing force of the pressure oil that flows through the piston port portions 34 from the second chamber 32 against the spring force of the first leaf valve 50. The upper surface of the piston body 26 serves as the seating surface of the first leaf valve 50. The first leaf valve 50 is composed of a plurality of thin metal plates having different outer diameters that are stacked one on another in the vertical direction.

As seen in FIG. 3, the first leaf valve 50 is composed of a large-diameter valve plug 66a in the shape of a large-diameter circular disc that is located in the lowermost position and seated on the seating surface, a first medium-diameter valve plug 66b and a second medium-diameter valve plug 66c having diameters smaller than that of the large-diameter valve plug 66a and stacked on the upper surface of the large-diameter valve plug 66a, and a small-diameter valve plug 66d having a diameter smaller than those of the first medium-diameter valve plug 66b and the second medium-diameter valve plug 66c and stacked on the upper surface of the second medium-diameter valve plug 66c. A stopper seat 58 is stacked on the upper surface of the small-diameter valve plug 66d, so that the first leaf valve 50 is pressed against the seating surface by the stopper seat 58. A clearance is provided in the vertical direction between the lower surface of the stopper seat 58 and the second medium-diameter valve plug 66c.

The second leaf valve 56 is bent downward to open the valve by means of the pressing force of the pressure oil that flows through the piston port portions 34 from the first chamber 30 against the spring force of the second leaf valve 56. The lower surface of the piston body 26 serves as the seating surface of the second leaf valve 56. The second leaf valve 56 is composed of a plurality of thin metal plates having different outer diameters that are stacked one on another in the vertical direction.

As seen in FIG. 3, the second leaf valve 56 is composed of a large-diameter valve plug 68a in the shape of a large-diameter circular disc that is located in the uppermost position and seated on the seating surface, a first medium-diameter valve plug 68b and a second medium-diameter valve plug 68c having diameters smaller than that of the large-diameter valve plug 68a and stacked on the lower surface of the large-diameter valve plug 68a, and a small-diameter valve plug 68d having a diameter smaller than those of the first medium-diameter valve plug 68b and the second medium-diameter valve plug 68c and stacked on the lower surface of the second medium-diameter valve plug 68c. A sub-valve 60 to be described later is provided on the lower surface of the small-diameter valve plug 68d.

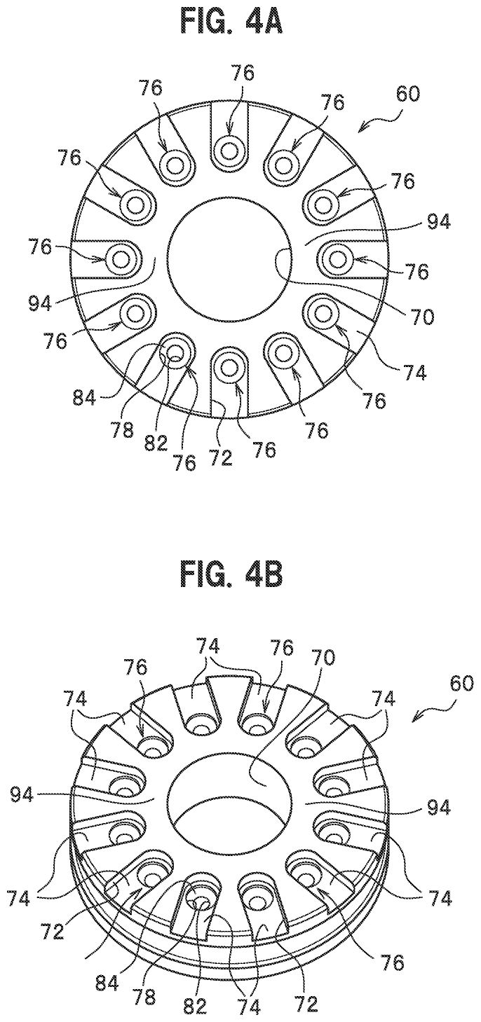

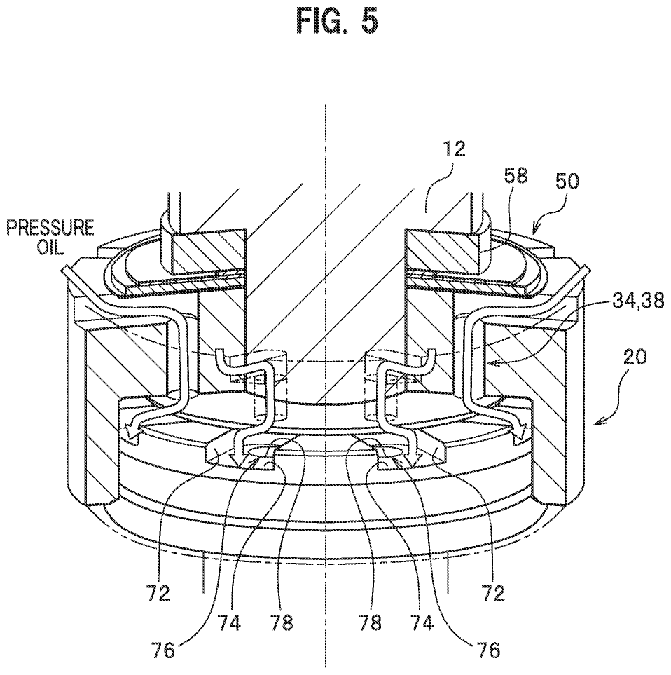

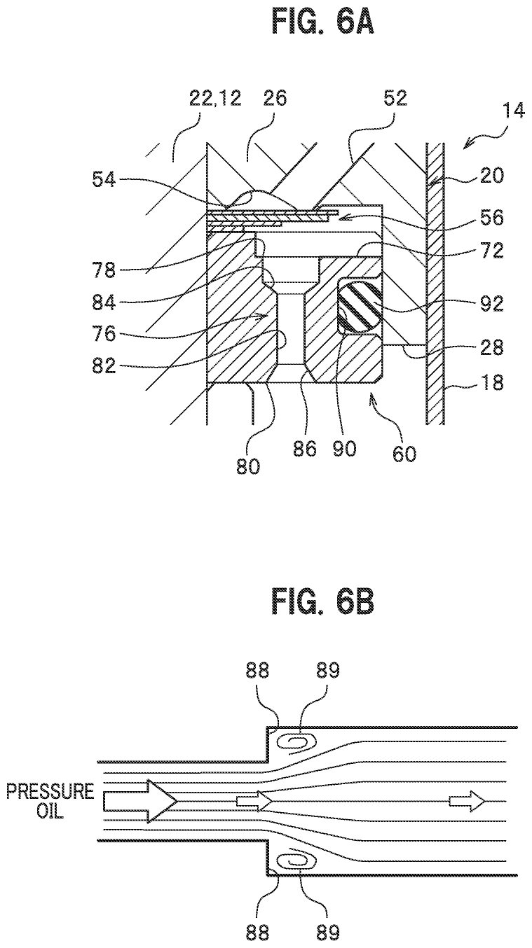

FIG. 4A is a plan view of the sub-valve, FIG. 4B is a perspective view of the sub-valve, FIG. 5 is a partially broken perspective view showing a flowing state of the pressure oil at detention portions provided in the sub-valve, FIG. 6A is a partially enlarged cross-sectional view showing a sealing state of an O-ring fitted in an annular groove, and FIG. 6B is a schematic diagram showing a modified embodiment of the sub-valve port portion.

Further, as seen in FIG. 2, the hydraulic damper 10 includes the sub-valve 60 disposed on the lower side of the second leaf valve 56. The sub-valve 60 has a bore 70 at its center portion, and the reduced-diameter rod portion 22 of the piston rod 12 is attached to the bore 70. As seen in FIGS. 4A and 4B, the sub-valve 60 is composed of an annular member made, for example, of a metallic material.

As seen in FIG. 3, the sub-valve 60 is disposed downstream of the second leaf valve 56 and upstream of the first leaf valve 50. A plurality of detention portions 74 are provided on the upper surface of the sub-valve 60. The detention portions 74 are formed by recesses 72 that extend radially from the vicinity of the bore 70 to the circumferential edge portion of the sub-valve 60 and are recessed toward a lower surface of the annular member. The detention portions 74 are arranged radially from the proximity of the bore 70 such that they are spaced apart by a predetermined angle along the circumferential direction of the sub-valve 60. The detention portions 74 allow the pressure oil flowing from the piston port portions 34 to be temporarily retained.

A sub-valve port portion 76 is provided in each of the detention portions 74. The sub-valve port portion 76 is in communication with a flow path of each of the piston port portions 34, and is disposed in the vicinity of the bore 70. As seen in FIG. 2, the sub-valve port portion 76 includes a first opening 78 formed in a bottom surface of the detention portion 74 and having a circular shape, a second opening 80 formed in the lower surface of the annular member and having a circular shape, and a passageway 82 connecting the first opening 78 and the second opening 80. The passageway 82 has a substantially constant inner diameter and extends substantially parallel to the axis of the reduced-diameter rod portion 22.

A first tapered portion 84 is provided in the sub-valve port portion 76. The first tapered portion 84 has a tapered cross-sectional shape in which the inner diameter thereof is gradually enlarged from the upper end of the passageway 82 to the first opening 78. Further, a second tapered portion 86 is provided. The second tapered portion 86 has a tapered cross-sectional shape in which the inner diameter thereof is gradually enlarged from the lower end of the passageway 82 to the second opening 80. According to this embodiment, the cross-sectional shape of the first tapered portion 84 and the cross-sectional shape of the second tapered portion 86 are different from each other to provide different diffuser shapes. It should be noted that the cross-sectional shape of the first tapered portion 84 and the cross-sectional shape of the second tapered portion 86 may be the same to provide the same diffuser shape.

According to a modified embodiment of the sub-valve port portion 76 as shown in FIG. 6B, a stepped shape portion 88 having a stepped shape may be provided between the upper end of the passageway 82 and the first opening 78 and/or a stepped shape portion 88 having a stepped shape may be provided between the lower end of the passageway 82 and the second opening 78.

As seen in FIG. 6A, an O-ring 92 is fitted in an annular groove 90 formed in an outer circumferential surface of the sub-valve 60. The O-ring 92 can tightly contact the inner circumferential surface of the annular protrusion 28 of the piston 20 to provide a sealing performance.

The total cross-sectional area (S2) of flow paths of the sub-valve port portions 76 is smaller than the total cross-sectional area (S1) of flow paths of the piston port portions 34 (S1>S2). A detailed description will be given later to this point.

The hydraulic damper 10 according to this embodiment is basically configured as described above. The operation and effects of the hydraulic damper 10 are described below.

First, a description is given to the case where an input load is applied to the piston rod 12 of the hydraulic damper 10 in the pressing direction so that the pressure oil flows in the pressing direction (from the lower second chamber 32 to the upper first chamber 30). As shown in the drawings, the pressure oil in the second chamber 32 flows through the sub-valve port portions 76 of the sub-valve 60 in the order of the second openings 80, the passageways 82, and the first openings 78. Further, the pressure oil passes through the first connecting paths 36 of the piston port portions 34 of the piston 20 that are in communication with the sub-valve port portions 76 of the sub-valve 60, and presses the first leaf valve 50 toward the first chamber 30 (upward). If the pressing force of the pressure oil applied to the first leaf valve 50 overcomes the spring force of the first leaf valve 50, the first leaf valve 50 bends upward and moves away from the seating surface to open the valve. Accordingly, the second chamber 32 and the first chamber 30 are in fluid communication with each other, and the pressure oil in the second chamber 32 is supplied to the first chamber 30. As a result, the piston 20 descends together with the piston rod 12 to pressurize the pressure oil in the second chamber 32.

This allows the hydraulic damper 10 to generate a damping force corresponding to the input load of the piston rod 12 in the pressing direction thanks to the flow path resistance generated when the pressure oil flows through the sub-valve port portions 76 of the sub-valve 60 and the flow path resistance generated when the pressure oil flows through the piston port portions 34 (first connecting paths 36) of the piston 20.

Next, a description is given to the case where an input load is applied to the piston rod 12 of the hydraulic damper 10 in the extending direction so that the pressure oil flows in the extending direction (from the upper first chamber 30 to the lower second chamber 32). As shown in the drawings, the pressure oil in the first chamber 30 flows through the second connecting paths 38 of the piston port portions 34 of the piston 20, and presses the second leaf valve 56 that is disposed on the lower side of the piston 20 toward the second chamber 32 (downward). If the pressing force of the pressure oil applied to the second leaf valve 56 overcomes the spring force of the second leaf valve 56, the second leaf valve 56 bends downward and moves away from the seating surface to open the valve. Further, the pressure oil having passed through the second leaf valve 56 flows through the sub-valve port portions 76 of the sub-valve 60 in the order of the first openings 78, the passageways 82, and the second openings 80. Accordingly, the first chamber 30 and the second chamber 32 are in fluid communication with each other, and the pressure oil in the first chamber 30 is supplied to the second chamber 32. As a result, the piston 20 ascends together with the piston rod 12 to pressurize the pressure oil in the first chamber 32.

This allows the hydraulic damper 10 to generate a damping force corresponding to the input load of the piston rod 12 in the extending direction thanks to the flow path resistance generated when the pressure oil flows through the piston port portions 34 (second connecting paths 38) of the piston 20 and the flow path resistance generated when the pressure oil flows through the sub-valve port portions 76 of the sub-valve 60. As a result, ride comfort of the vehicle to which the hydraulic damper according to this embodiment is applied can be improved.

According to this embodiment, the sub-valve 60 is disposed upstream of the first leaf valve 50 and downstream of the second leaf valve 56. The sub-valve 60 is provided with the sub-valve port portions 76 that are connected to the first connecting paths 36 and the second connecting paths 38 of the piston port portions 34. The total cross-sectional area (S2) of the flow paths of the sub-valve port portions 76 is smaller than the total cross-sectional area (S1) of the flow paths of the piston port portions 34 (S1>S2).

According to this embodiment, providing the sub-valve port portions 76 in the sub-valve 60 makes it possible to set the damping force separately from the first leaf valve 50 and the second leaf valve 56 that serve as a damping force generating device. Further, since the total cross-sectional area (S2) of the flow paths of the sub-valve port portions 76 is made smaller than the total cross-sectional area (S1) of the flow paths of the piston port portions 34 (S1>S2), it is possible to increase the flow path resistance relative to the pressure oil. As a result, according to this embodiment, the damping force generated by the hydraulic damper 10 can be set simply by changing the cross-sectional area of the flow paths of the sub-valve port portions 76 in the sub-valve 60. This can contribute to a reduction in the man-hour requirements for development. The reduction in the man-hour requirements for development can also lead to a reduction in CO2 emissions that is an environmental issue.

According to this embodiment, it is possible to provide the hydraulic damper 10 that can reduce the man-hour requirements for development when setting damping force.

According to this embodiment, the hydraulic damper 10 can generate greater damping force in a high speed range of piston speed and in an extremely low speed range of piston speed. Further, the magnitude of the absolute value of the damping force can be easily adjusted by replacing with a modified component (sub-valve 60).

According to this embodiment, each of the sub-valve port portions 76 has the first opening 78, the second opening 80, and the passageway 82 connecting the first opening 78 and the second opening 80. Further, the sub-valve port portion 76 is provided with the first tapered portion 84 and the second tapered portion 86. The first tapered portion 84 has a tapered cross-sectional shape in which the inner diameter thereof is gradually enlarged from the upper end of the passageway 82 to the first opening 78, and the second tapered portion 86 has a tapered cross-sectional shape in which the inner diameter thereof is gradually enlarged from the lower end of the passageway 82 to the second opening 80.

According to this embodiment, since the first tapered portion 84 and the second tapered portion 86, in which the cross-sectional area of the opening is gradually enlarged from the passageway 82 to the opening, are provided, the cross-sectional area of the flow path through which the pressure oil flows can be smoothly changed to reduce the flow path resistance of the pressure oil. Further, according to this embodiment, since the cross-sectional shape of the first tapered portion 84 and the cross-sectional shape of the second tapered portion 86 are different from each other to provide different diffuser shapes, it is possible to simplify the setting of the flow path resistance.

In a modified embodiment of the sub-valve port portion 76 shown in FIG. 6B, the stepped shape portion 88 having a stepped shape is provided between the upper end of the passageway 82 and the first opening 78, and the stepped shape portion 88 having a stepped shape is provided between the lower end of the passageway 82 and the second opening 78.

In this modified embodiment, since the sub-valve port portion 76 is provided with the stepped shape portion 88 (see FIG. 6B), an abrupt change in the cross-section of the flow path can occur to generate vortexes 89 (see FIG. 6B) that cannot flow along the flow path. This can increase the flow path resistance. As a result, according to this modified embodiment, it is possible to increase or decrease the damping force generated in accordance with the flow direction of the pressure oil.

Further, according to this embodiment, the detention portions 74 configured to retain flowing pressure oil are provided between the piston port portions 34 and the sub-valve port portions 76. In this embodiment, since the detention portions 74 are provided in the sub-valve port portions 76, when the pressure oil flowing from the piston port portions 34 passes through narrow spaces of the sub-valve 60, the pressure oil is smoothly distributed along the detention portions 74 without squeezing (without causing oil clogging) (see FIG. 5).

According to this embodiment, the damping force generating device includes the first leaf valve 50 disposed downstream of the piston port portions 34 in a direction in which the pressure oil flows in the pressing direction, and the second leaf valve 56 disposed downstream of the piston port portions 34 in a direction in which the pressure oil flows in the extending direction.

In this embodiment, the damping force of the hydraulic damper 10 can be simply set by merely changing the cross-sectional area of the flow paths of the sub-valve port portions 76 in the sub-valve 60. Accordingly, the conventional operations required for combining a plurality of discs in an infinite number of ways when leaf valves are applied to a hydraulic damper are not necessary. This can reduce man-hour requirements for development. Further, in this embodiment, since leaf valves are used as the damping force generating device, remarkable damping effect can be obtained as compared with an alternative configuration in which other valves, such as disc valve, rod valve, and spool valve are used as the damping force generating device.

Further, according to this embodiment, the O-ring 92 is fitted in the annular groove 90 that is formed in the outer circumferential surface of the sub-valve 60. The O-ring 92 can tightly contact the inner circumferential surface of the annular protrusion 28 of the piston 20 to provide a sealing performance. Since the O-ring 92 tightly contacts the inner circumferential surface of the annular protrusion 28 of the piston 20, it is possible to prevent the pressure oil from flowing between the outer circumferential surface of the sub-valve 60 and the inner circumferential surface of the annular protrusion 28 of the piston 20, so that the pressure oil can flow efficiently from the piston port portions 34 to the sub-valve port portions 76.

According to this embodiment, a plurality of sub-valve port portions 76 (twelve sub-valve port portions 76 are shown in FIG. 4A) are arranged circumferentially in the sub-valve 60. However, the present invention is not limited to this specific configuration, and the number of sub-valve port portions 76 may be changed where appropriate. The flow path resistance of the pressure oil can be reduced by increasing the number of sub-valve port portions 76. Meanwhile, the flow path resistance of the pressure oil can be increased by decreasing the number of sub-valve port portions 76.

According to this embodiment, an annular contact surface 94 is provided between the bore 70 of the sub-valve 60 and the sub-valve port portions 76 (see FIGS. 4A and 4B). The annular contact surface 94 can contact other components. Providing the annular contact surface 94 makes it possible to propagate the axial force of the piston rod 12 (reduced-diameter rod portion 22) in a stable manner.

Depending on a vehicle, such as passenger car, sport-type vehicle, recreational vehicle, and motorcycle, required damping force characteristics are different. However, according to this embodiment, if the shapes of the first openings 78 and/or the second openings 80 provided in the sub-valve port portions 76 of the sub-valve 60 are selected appropriately, the damping force characteristics suitable for each vehicle type can be obtained with ease. In other words, desired damping force characteristics can be obtained by the correlation between diameters of the openings and the number of sub-valve port portions 76.

Next, a hydraulic damper according to another embodiment is described below.

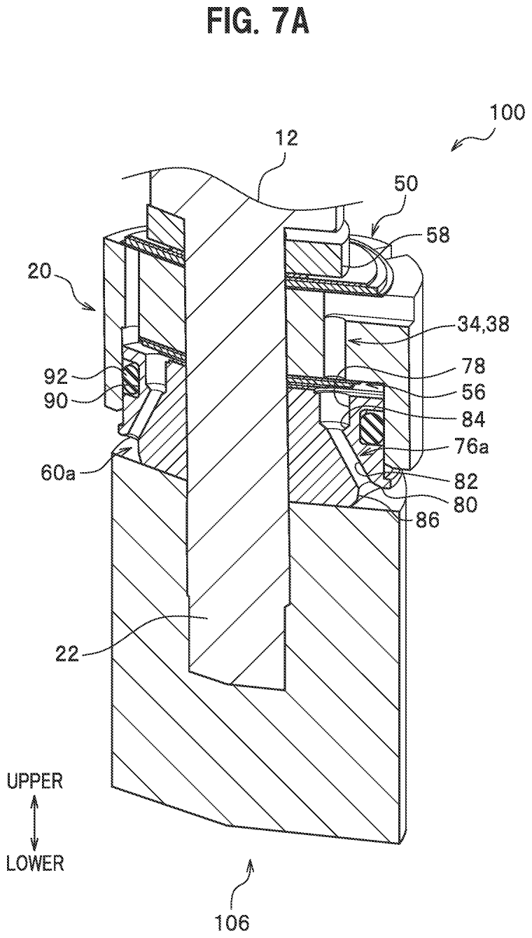

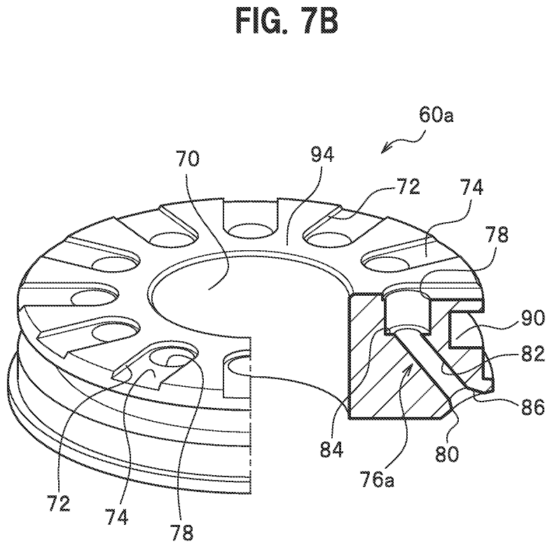

FIG. 7A is a cross-sectional view of an amplitude-selective damper to which the sub-valve is applied, taken along an axial direction of the damper, and FIG. 7B is a partially broken perspective view of the sub-valve shown in FIG. 7A. It should be noted that parts same as those described in the above embodiment as shown in FIGS. 1 to 6B are denoted by the same reference numerals.

An amplitude-selective damper 100 (vibration-selective damper) stabilizes the posture of the vehicle with a high damping force in the case of a large stroke, and absorbs more vibration with a low damping force in the case of a small stroke, so that a comfortable riding comfort of the vehicle can be ensured.

A sub-valve 60a applied to the amplitude-selective damper 100 is configured such that the passageways 82 and the second openings 80 of the sub-valve port portions 76a are not parallel to the axis of the reduced-diameter rod portion 22 and inclined obliquely downward in a direction from the bore toward the outer circumferential surface of the sub-valve 60a (see FIGS. 7A and 7B). A second piston (amplitude-selective mechanism) 106 that is disposed under the sub-valve 60a (see FIG. 7A) does not become an obstacle because of this inclination arrangement, so that the pressure oil can flow along the upper surface of the second piston 106.

What is claimed is:

1. A hydraulic damper comprising:
a cylinder having a cylinder tube;
a piston slidingly movable within the cylinder tube;
a piston rod connected to the piston at one end portion along an axial direction thereof and integrally movable with the piston;
a first chamber and a second chamber into or from which fluid flows by sliding movement of the piston relative to the cylinder tube;
a piston port portion connecting the first chamber and the second chamber; and
a damping force generating device disposed downstream of the piston port portion through which the fluid flows, wherein
the hydraulic damper further comprises a sub-valve disposed upstream and/or downstream of the damping force generating device,
the sub-valve is provided with a sub-valve port portion that is connected to a flow path of the piston port portion, and
a total cross-sectional area (S2) of a flow path of the sub-valve port portion is smaller than a total cross-sectional area (S1) of the flow path of the piston port portion (S1>S2).

2. The hydraulic damper according to claim 1, wherein
the sub-valve port portion has a first opening, a second opening, and a passageway connecting the first opening and the second opening, and
the sub-valve port portion has a tapered shape in which an inner diameter thereof is enlarged from the passageway toward the first opening or from the passageway toward the second opening.

3. The hydraulic damper according to claim 1, wherein
the sub-valve port portion has a first opening, a second opening, and a passageway connecting the first opening and the second opening, and
the sub-valve port portion has a stepped shape between the passageway and the first opening or between the passageway and the second opening.

4. The hydraulic damper according to claim 1, wherein
a detention portion configured to retain flowing fluid is provided between the piston port portion and the sub-valve port portion.

5. The hydraulic damper according to claim 1, wherein
the damping force generating device comprises a first leaf valve disposed downstream of the piston port portion in a direction in which the fluid flows in a pressing direction, and a second leaf valve disposed downstream of the piston port portion in a direction in which the fluid flows in an extending direction.

6. The hydraulic damper according to claim 1, wherein
an O-ring is attached to an outer circumferential surface of the sub-valve.
